(19) United States
(12) Patent Application Publication
(10) Pub. No.: US 2007/0285678 A1
(43) Pub. Date: Dec. 13, 2007

(54) Recording apparatus

(75) Inventor: Toshinori Matsunami, Kitakyushu-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/787,039

(22) Filed: Apr. 12, 2007

(30) Foreign Application Priority Data
Apr. 12, 2006 (JP) 2006-109683
Mar. 26, 2007 (JP) 2007-079584

(51) Int. Cl. B41J 2/01

(52) U.S. Cl. 358/1.1

(57) ABSTRACT

DC power supplied from an AC adaptor to a docking station is supplied to a station power circuit and is also supplied to a printer power circuit. The docking station includes a transistor capable of switching on and off a path of supply of DC power from the AC adaptor to the printer power circuit. An operation state of a power switch of the main printer body can be detected in both a printer control device and a station control device. A one-pulse circuit causes a PC terminal of the printer power circuit to have a GND potential only for a predetermined period of time at the start of supply of DC power that is supplied from the AC adaptor to the docking station.

The present application claims priority from Japanese Application Nos. 2006-109683, filed on Apr. 12, 20066 and 2007-079584, filed on Mar. 26, 2007, both of which are incorporated by reference in their entirety.

### BACKGROUND OF THE INVENTION

1. Technical Field

The present invention relates to a recording apparatus configured to be separable into a main body of a recording apparatus and a docking station.

2. Background Art

In recent years, a multi-functional composite printer having a scanner function and the like has come into wide use as a recording apparatus such as an ink jet printer. In addition, improvements corresponding to user's various needs in terms of functions are being made as well as improvements in terms of a performance, such as recording quality or recording speed. As an example, a small and portable printer, which is so light as to be portable and which is capable of performing digital photograph printing easily and anywhere, has been developed and come into wide use. Here, the problem is that as the number of functions provided increases, the more difficult miniaturization is. Therefore, in order to improve portability by making a recording apparatus, such as an ink jet printer, small, it is necessary to reduce the number of practical functions to some extent.

As an example of a device in the known art capable of having an increased number of functions as necessary while maintaining the portability of a small and portable electronic apparatus, a docking station for increasing the number of functions of a notebook computer is known (for example, refer to JP-A-11-212684). By providing such docking station, it is possible to increase the number of functions of a notebook computer using a CD-ROM drive, a second battery, a printer, and the like mounted in the docking station side when the notebook computer is connected with the docking station, while maintaining essential functions of the notebook computer when the notebook computer is not connected with the docking station.

However, a notebook computer and a recording apparatus, such as an ink jet printer, have different configurations and functions. Accordingly, a docking station of the recording apparatus, such as the ink jet printer, is required to have a function and configuration corresponding to those unique to the recording apparatus such as the ink jet printer.

The present invention has been finalized in view of the above situation, and it is an object of the present invention to improve user's convenience in a recording apparatus having a docking station.

### SUMMARY OF THE INVENTION

In order to achieve the above object, according to a first aspect of at least one embodiment of the present invention, a recording apparatus includes: a first recording apparatus unit and a second recording apparatus unit configured to be separable from each other. In a state in which the first recording apparatus unit and the second recording apparatus unit are connected with each other, power of the first recording apparatus unit and power of the second recording apparatus unit are turned on and off simultaneously in conjunction with each other.

In the state in which the first recording apparatus unit and the second recording apparatus unit are connected with each other, power of the first recording apparatus unit is turned on by performing a power ON operation on the first recording apparatus unit and power of the second recording apparatus unit is also turned on in conjunction with the power ON of the first recording apparatus unit. In addition, the power of the first recording apparatus unit is turned off by performing a power OFF operation on the first recording apparatus unit and the power of the second recording apparatus unit is also turned off in conjunction with the power OFF of the first recording apparatus unit. Similarly, the power of the second recording apparatus unit is turned on by performing a power ON operation on the second recording apparatus unit and the power of the first recording apparatus unit is also turned on in conjunction with the power ON of the second recording apparatus unit. In addition, the power of the second recording apparatus unit is turned off by performing a power OFF operation on the second recording apparatus unit and the power of the first recording apparatus unit is also turned off in conjunction with the power OFF of the second recording apparatus unit.

That is, in the state in which the first recording apparatus unit and the second recording apparatus unit are connected with each other, it is possible to turn on and off the first recording apparatus unit and the second recording apparatus unit at the same time by performing a power ON/OFF operation on any one of the first recording apparatus unit and the second recording apparatus unit. Therefore, when using the recording apparatus in the state in which the first recording apparatus unit and the second recording apparatus unit are connected with each other, it is not necessary to perform both a power ON/OFF operation on the first recording apparatus unit and a power ON/OFF operation on the second recording apparatus unit. As a result, an effect that user's convenience can be improved in the recording apparatus configured to be separable into the first recording apparatus unit and the second recording apparatus unit is obtained.

According to a second aspect of at least one embodiment of the present invention, in the recording apparatus according to the first aspect described above, the first recording apparatus unit has a configuration capable of executing recording onto a recording material, and the second recording apparatus unit has display operation means for the recording apparatus.

In the recording apparatus configured to include the first recording apparatus unit, which has a function of executing recording onto a recording material, and the second recording apparatus unit having the display operation means, such as a liquid crystal display, an operation screen video output terminal, operation buttons, a touch panel, and a remote control, it is possible to obtain the same effect as in the invention described in the first aspect.

According to a third aspect of at least one embodiment of the present invention, a recording apparatus includes a main body of the recording apparatus having a configuration capable of executing recording onto a recording material and a docking station, the main body of the recording apparatus and the docking station being separable from each other. In a state in which the main body of the recording apparatus and the docking station are connected with each other, power of the main body of the recording apparatus and power of the docking station are turned on and off simultaneously in conjunction with each other.

Here, the main body of the recording apparatus has at least an essential function required for recording onto a recording material, such as recording paper, in the recording apparatus such as an ink jet printer. This means that the recording onto recording paper can be executed by only the recording apparatus. In addition, the docking station is a dedicated function extension unit that forms a part of the recording apparatus in the state where the docking station is connected with the main body of the recording apparatus and can be separated from the main body of the recording apparatus. The main body of the recording apparatus separated from the docking station serves as a portable and small recording apparatus by itself, and the main body of the recording apparatus connected with the docking station serving as the function extension unit serves as a multi-function recording apparatus since a function as a recording apparatus extends.

In the state in which the main body of the recording apparatus and the docking station are connected with each other, power of the main body of the recording apparatus is turned on by performing a power ON operation on the main body of the recording apparatus and power of the docking station is also turned ON in conjunction with the power ON of the main body of the recording apparatus. In addition, the power of the main body of the recording apparatus is turned off by performing a power OFF operation on the main body of the recording apparatus and the power of the docking station is also turned off in conjunction with the power OFF of the main body of the recording apparatus. Similarly, the power of the docking station is turned on by performing a power ON operation on the docking station and the power of the main body of the recording apparatus is also turned on in conjunction with the power ON of the docking station. In addition, the power of the docking station is turned off by performing a power OFF operation on the docking station and the power of the main body of the recording apparatus is also turned off in conjunction with the power OFF of the docking station.

That is, in the state in which the docking station is connected to the main body of the recording apparatus, it is possible to turn on and off the main body of the recording apparatus and the docking station at the same time only by performing a power ON/OFF operation on any one of the main body of the recording apparatus and the docking station. Therefore, when using the recording apparatus in the state in which the docking station is connected to the main body of the recording apparatus, it is not necessary to perform both the power ON/OFF operation on the main body of the recording apparatus and the power ON/OFF operation on the docking station. As a result, an effect that the user's convenience can be improved in the recording apparatus having the docking station is obtained.

According to a fourth aspect of at least one embodiment of the present invention, in the recording apparatus according to the third aspect described above, the main body of the recording apparatus is configured to operate with power supplied from the docking station in a state in which the main body of the recording apparatus is connected with the docking station.

In the state in which the docking station is connected to the main body of the recording apparatus, if power supply means, such as an AC adaptor, is connected to only the docking station, the power from the AC adaptor or the like is supplied to both the main body of the recording apparatus and the docking station. Accordingly, since it is not necessary to separately connect the AC adaptor to both the main body of the recording apparatus and the docking station, an effect that the user's convenience can be improved in the recording apparatus having the docking station is obtained.

According to a fifth aspect of at least one embodiment of the present invention, in the recording apparatus according to the fourth aspect described above, the docking station turns on and off supply of power to the main body of the recording apparatus simultaneously in conjunction with power ON/OFF of the docking station, and the recording apparatus is turned on and off simultaneously in conjunction with ON/OFF of power supply from the docking station.

Thus, the supply of power from the docking station to the main body of the recording apparatus is turned on and off in conjunction with the power ON/OFF of the docking station and the power of the main body of the recording apparatus is turned on and off in conjunction with ON/OFF of the supply of power to the main body of the recording apparatus. Accordingly, it is possible to turn on and off the power of the main body of the recording apparatus in conjunction with the power ON/OFF of the docking station.

According to a sixth aspect of at least one embodiment of the present invention, in the recording apparatus according to the fifth aspect described above, power of the recording apparatus is automatically turned on when the recording apparatus is connected to the docking station in which supply of power to the recording apparatus is in an ON state.

In the case of a recording apparatus, such as an ink jet printer, it is considered that in many cases, connecting a main body of the recording apparatus to a docking station that is in a power ON state is performed to execute recording onto a recording material, such as recording paper. Accordingly, by causing the power of the main body of the recording apparatus to be automatically turned on without a user's operation for turning on the power of the main body of the recording apparatus at a point of time when the main body of the recording apparatus is connected to the docking station that is in the power ON state, the user can immediately operate the main body of the recording apparatus to perform recording onto a recording material without additionally performing the power ON operation on the main body of the recording apparatus.

According to a seventh aspect of at least one embodiment of the present invention, in the recording apparatus according to the sixth aspect described above, a contact state of a power switch of the connected main body of the recording apparatus is also input to the docking station, and the docking station turns on and off power of the docking station in correspondence with an operation of the power switch of the main body of the recording apparatus and turns on and off supply of power to the main body of the recording apparatus simultaneously in conjunction with power ON/OFF of the docking station.

Thus, the power of the docking station is turned on by the power switching operation on the main body of the recording apparatus, the supply of power from the docking station to the main body of the recording apparatus is turned on and off in conjunction with the power ON/OFF of the docking station, and the power of the main body of the recording apparatus is turned on and off in conjunction with ON/OFF of the supply of power to the main body of the recording apparatus. As a result, the power of the docking station can also be turned on and off in conjunction with the power ON/OFF operation on the main body of the recording apparatus by means of the power switch of the main body of the recording apparatus.

According to an eighth aspect of at least one embodiment of the present invention, in the recording apparatus according to any one of the fifth to seventh aspects described above, the docking station turns on and off supply of power to the main body of the recording apparatus simultaneously in conjunction with power ON/OFF of the docking station through a remote control operation.

Thus, the power of the docking station is turned on by the power ON/OFF of the docking station based on a remote control operation, the supply of power from the docking station to the main body of the recording apparatus is turned on and off in conjunction with the power ON/OFF of the docking station, and the power of the main body of the recording apparatus is turned on and off in conjunction with ON/OFF of the supply of power to the main body of the recording apparatus. As a result, the power of the main body of the recording apparatus can also be turned on and off in conjunction with the power ON/OFF operation on the docking station using a remote control operation.

### BRIEF DESCRIPTION OF THE DRAWINGS

FIG. 1 is a view schematically illustrating the configuration of an ink jet printer according to an embodiment of the present invention.

FIG. 2 is a block diagram illustrating the ink jet printer according to the embodiment of the present invention.

FIG. 3 is a view illustrating main parts in a power system of the ink jet printer.

FIG. 4 is a circuit diagram illustrating an example of a one-pulse circuit.

FIG. 5 is a timing chart illustrating the power ON/OFF control.

### DETAILED DESCRIPTION OF THE PREFERRED EMBODIMENTS

Hereinafter, an embodiment of the present invention will be described with reference to the accompanying drawings.

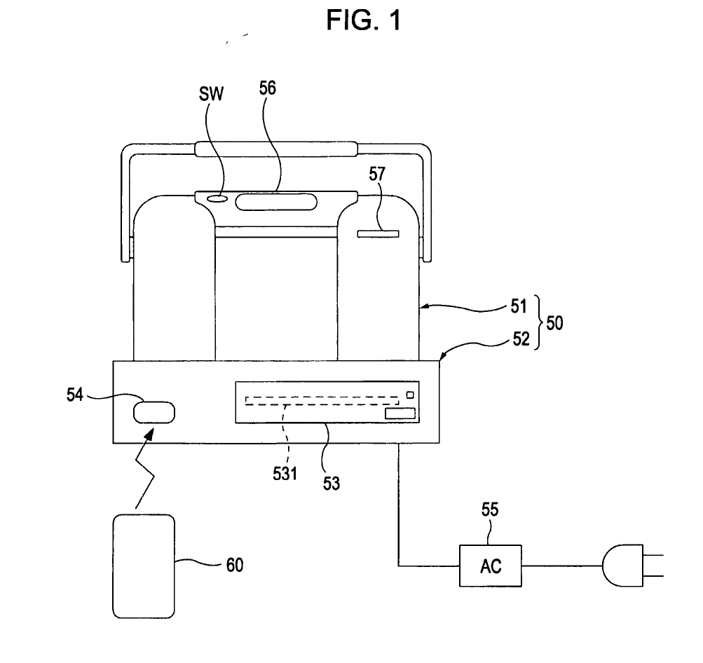

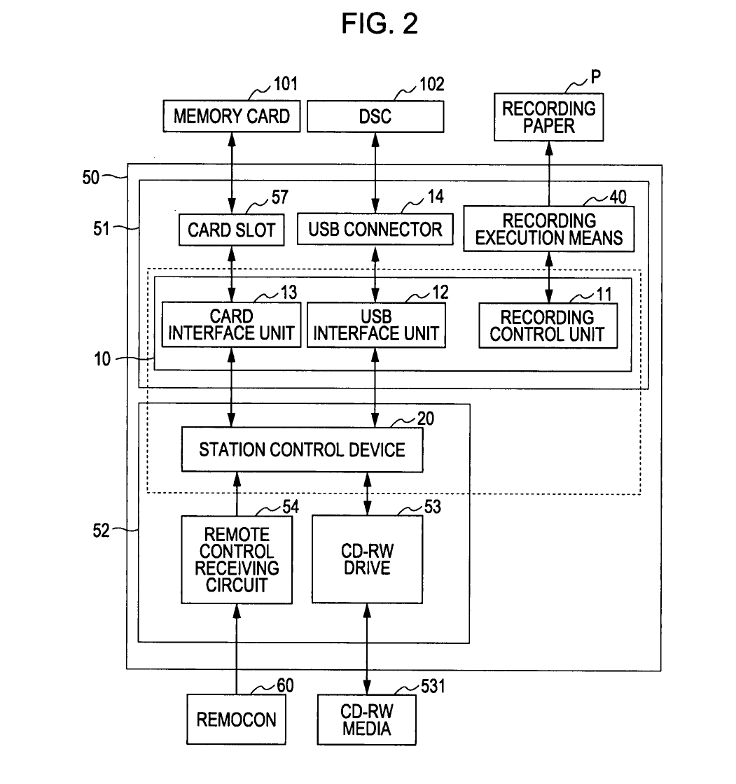

FIG. 1 is a view schematically illustrating the configuration of an ink jet printer 50 as a ‘recording apparatus’ according to an embodiment of the present invention. FIG. 2 is a block diagram illustrating the ink jet printer 50 as the ‘recording apparatus’ according to the embodiment of the present invention.

The ink jet printer 50 as the ‘recording apparatus’ according to the embodiment of the present invention includes a main printer body 51, which serves as a ‘first recording apparatus unit’ and a ‘main body of the recording apparatus’, and a docking station 52 serving as a ‘second recording apparatus unit’. Each of the main printer body 51 and the docking station 52 has an individual control device. The main printer body 51 is controlled by a printer control device 10 and the docking station 52 is controlled by a station control device 20, and the main printer body 51 and the docking station 52 are configured to be able to operate independently. In addition, in a state in which the main printer body 51 is connected (docked) with the docking station 52, the printer control device 10 and the station control device 20 are connected to each other by a USB interface such that information can be transmitted therebetween.

The main printer body 51 has a configuration in which recording (printing) onto a recording paper P can be executed by itself. In addition, the main printer body 51 includes: recording execution means 40 having a configuration in which recording can be executed by causing ink to be ejected from a recording head (not shown) onto the recording paper P serving as a ‘recording material’; a power switch SW; an operation panel 56 serving as ‘display operation means’ for realizing a display operation function, such as a recording execution operation performed by a user; a card slot 57 for realizing a function of inputting data from a memory card 101; and the printer control device 10. The printer control device 10 includes a recording control unit 11, a USB interface unit 12, and a card interface unit 13.

In addition, the operation panel 56 may be provided in the docking station 52 instead of the main printer body 51.

Using the card interface unit 13, input/output of data to/from the memory card 101 inserted in the card slot 57 is realized and it is possible to input a digital image file stored in the memory card 101. The USB interface unit 12 has a function for realizing input/output of data to/from a digital image processing apparatus, such as a DSC (digital still camera) 102, and for realizing USB data communication between the printer control device 10 and the station control device 20. The recording control unit 11 makes a driving control on the recording execution means 40 on the basis of a digital image file input through the USB interface unit 12 or the card interface unit 13, such that an image is recorded on a recording surface of the recording paper P.

The docking station 52 is a dedicated function extension unit that forms a part of the ink jet printer 50 in the state in which the docking station 52 is connected with the main printer body 51 and can be separated from the main printer body 51. The docking station 52 includes a CD-RW drive 53, a remote control receiving circuit 54, a remote control unit 60, and the station control device 20. The CD-RW drive 53 has a function of reading data from the CD-RW media 531 and a function of writing data onto the CD-RW media 531. The remote control receiving circuit 54 has a configuration in which power ON/OFF operation of the docking station 52 is possible by the remote control unit 60 as ‘display operation means’ for realizing a display operation function, such as a recording execution operation, by means of a user.

Moreover, the docking station 52 has an operation screen video output terminal (not shown), and an operation screen of the ink jet printer 50 can be displayed on a screen of a display device, such as a television, by connecting the operation screen video output terminal to the display device, such as the television, using a cable or the like. The user can instruct performance of an operation on the ink jet printer 50 by operating the remote control unit 60 while viewing the operation screen.

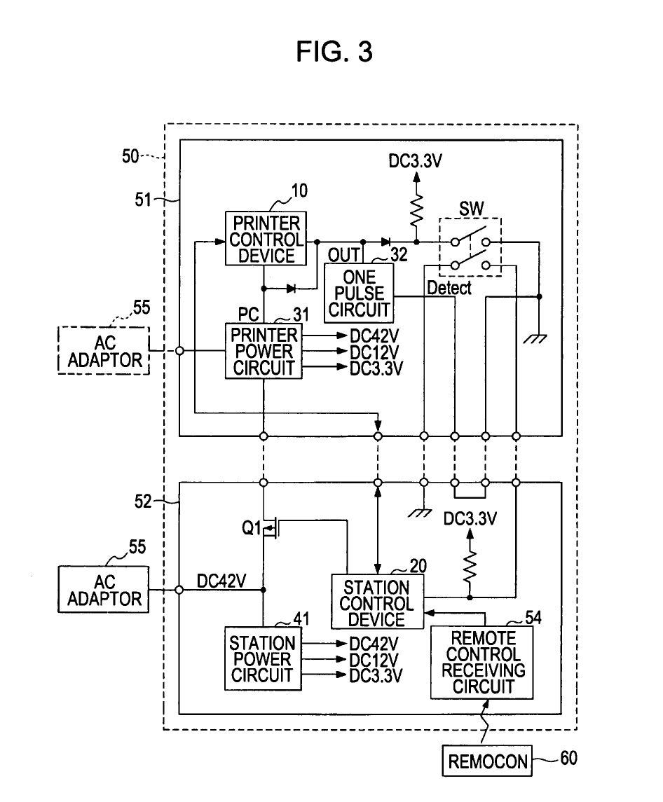

FIG. 3 is a view illustrating main parts in a power system of the ink jet printer 50.

The docking station 52 has a configuration in which an AC adaptor 55 that converts AC power supplied from the outside into DC power is connectable thereto. The docking station 52 and the main printer body 51 connected to the docking station 52 operate with DC power (DC 42 V) supplied from the AC adaptor 55. DC power supplied from the AC adaptor 55 to the docking station 52 is supplied to a station power circuit 41 serving as a power source of the docking station 52 and is supplied to a printer power circuit 31 serving as a power source of the main printer body 51. Since it is not necessary to separately connect the AC adaptor 55 to both the main printer body 51 and the docking station 52, it is possible to improve the convenience of use of the ink jet printer 50 having the docking station 52.

Further, in the docking station 52, a transistor Q1 is provided in a path along which DC power is supplied from the AC adaptor 55 to the printer power circuit 31 of the main printer body 51. The docking station 52 has a configuration in which supply of the DC power from the AC adaptor 55 to the printer power circuit 31 of the main printer body 51 is turned on and off by turning on and off the transistor Q1. The transistor Q1 is a field effect transistor (FET) and an on/off control of the transistor Q1 is made by the station control device 20. Furthermore, in a state in which the main printer body 51 is separated from the docking station 52, the AC adaptor 55 may be directly connected to the main printer body 51 such that power is directly supplied from the AC adaptor 55 to the main printer body 51 in order to operate the main printer body 51.

The main printer body 51 has a configuration in which the printer power circuit 31 operates with DC power supplied from the AC adaptor 55 and the printer control device 10 operates at DC 3.3 V output from the printer power circuit 31. The printer power circuit 31 operates in the state in which DC power from the AC adaptor 55 is supplied thereto and a PC (power control) terminal of the printer power circuit 31 has a GND potential. The power switch SW has two independent contact circuits operating in conjunction with a switch operation, and the contact circuits are formed only while the power switch SW is being pressed.

If the power switch SW is pressed, a PC terminal of the printer power circuit 31 and a contact input port of the printer control device 10 are short-circuited to GND of the main printer body 51 by one of the contact circuits, and a contact input port of the station control device 20 of the main printer body 51 is short-circuited to GND of the docking station 52 by the other contact circuit. That is, the operation state of the power switch SW of the main printer body 51 can be detected in both the printer control device 10 and the station control device 20.

A one-pulse circuit 32 has a configuration in which a PC terminal of the printer power circuit 31 maintains a GND potential for a predetermined period of time (about 1 to 2 seconds) when the main printer body 51 is connected (docked) with the docking station 52. In addition, the one-pulse circuit 32 has a configuration in which the PC terminal of the printer power circuit 31 maintains a GND potential for a predetermined period of time (about 1 to 2 seconds) at the start of supply of DC power (DC 42 V) of the AC adaptor 55 supplied from the docking station 52 through the transistor Q1 while the main printer body 51 is being connected (docked) to the docking station 52.

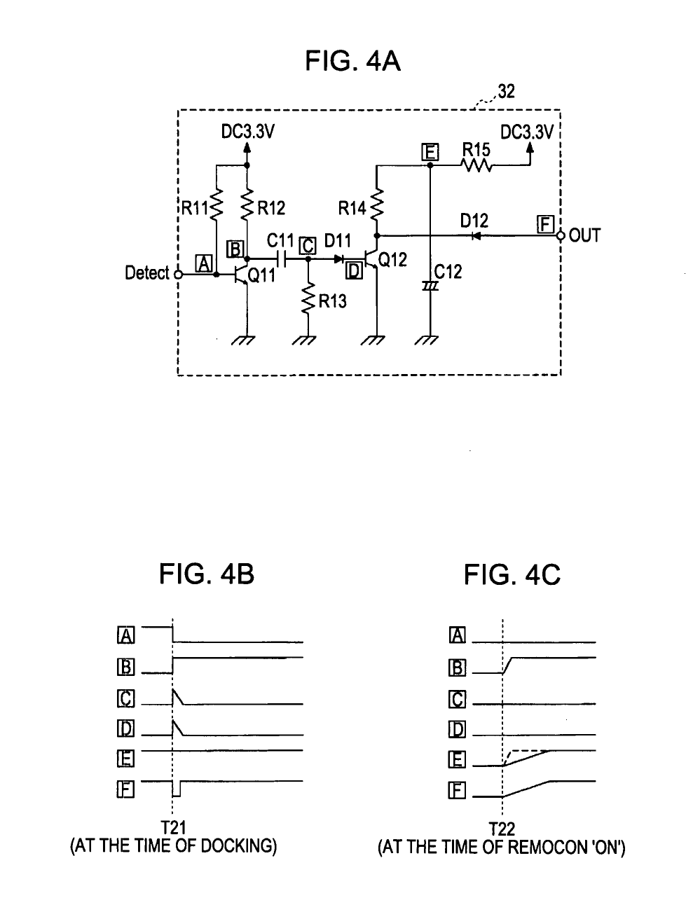

FIG. 4 is a circuit diagram and timing chart illustrating an example of the one-pulse circuit 32.

FIG. 4a is a circuit diagram illustrating the one-pulse circuit 32.

As for a transistor Q11, DC 3.3 V is applied to a base terminal through a resistor R11, DC 3.3 V is applied to a collector terminal through a resistor R12, and an emitter terminal is connected to GND. In addition, the base terminal of the transistor Q11 is connected to a ‘Detect’ terminal of the one-pulse circuit 32. A differential circuit using a capacitor C11 and a resistor R13 is provided between the collector terminal of the transistor Q11 and a base terminal of a transistor Q12. An output of the differential circuit is connected to the base terminal of the transistor Q12 through a diode D11. As for the transistor Q12, a collector terminal is connected to an ‘OUT’ terminal of the one-pulse circuit 32 through a diode D12 and an emitter terminal is connected to GND. In addition, an output of an integrating circuit configured to include a resistor R15 and a capacitor C12 is connected to the collector terminal of the transistor Q12 through a resistor R14. DC 3.3 V is connected to an input of the integrating circuit.

FIG. 4b is a timing chart when the main printer body 51 is connected (docked) to the docking station 52.

When the main printer body 51 is connected (docked) to the docking station 52 (timing T21), the Detect terminal (measurement point A) is short-circuited to GND (refer to FIG. 3) and the base terminal of the transistor Q11 has the GND potential, such that a base current does not flow. Accordingly, the transistor Q11 will switch from an ON state to an OFF state. When the transistor Q11 switches from the ON state to the OFF state, DC 3.3 V is input to the capacitor C11 of the differential circuit (measurement point B). By an output signal (measurement point C) of the differential circuit, a base current flows only for a predetermined period of time in the transistor Q12. Accordingly, the transistor Q12 switches to the ON state (measurement point D). As a result, the OUT terminal of the one-pulse circuit 32 connected to the collector terminal of the transistor Q12 has a GND potential only for a predetermined period of time (measurement point F).

FIG. 4c is a timing chart when power of the docking station 52 is turned on using the remote control unit 60.

When power of the docking station 52 is turned on using the remote control unit 60, DC power is supplied from the AC adaptor 55 to the printer power circuit 31, the printer power circuit 31 starts, and DC 3.3 V is applied from the printer power circuit 31 to the resistor R15 of the integrating circuit of the one-pulse circuit 32. Since a voltage of an output (measurement point E) of the integrating circuit gently increases on the basis of a time constant of the integrating circuit, the output of the integrating circuit maintains a voltage near a GND potential for a predetermined period of time after start of the printer power circuit 31. Accordingly, the OUT terminal (measurement point F) of the one-pulse circuit 32 maintains the GND potential for the predetermined period of time.

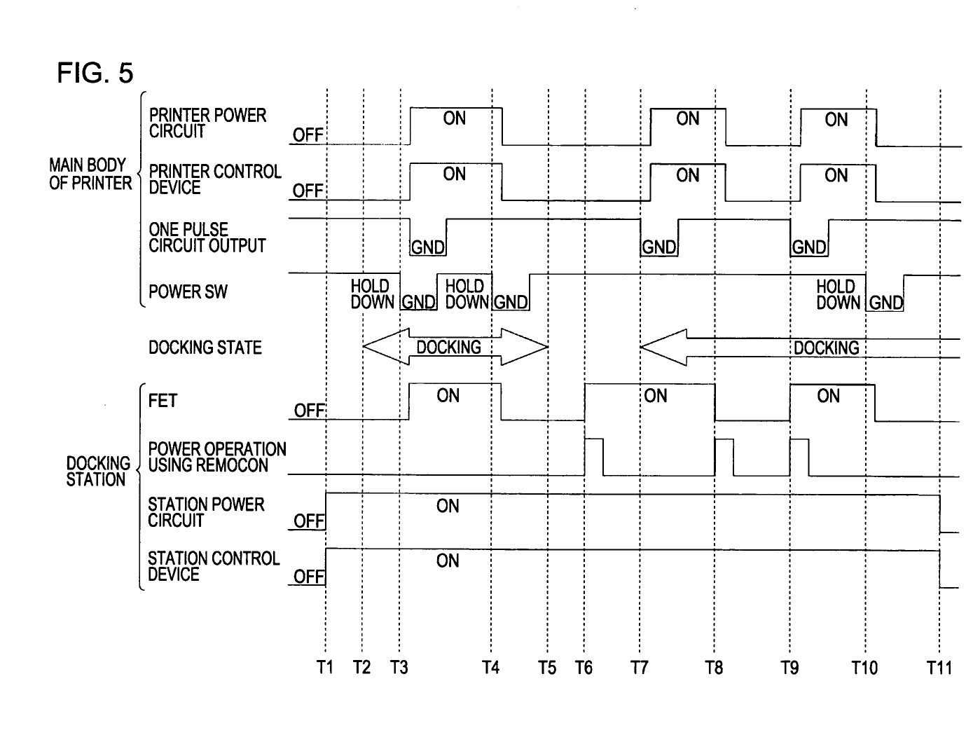

In the ink jet printer 50 having the above-described configuration according to the embodiment of the present invention, power of the main printer body 51 and power of the docking station 52 are turned on and off at the same time in conjunction with each other in the state in which the main printer body 51 and the docking station 52 are connected to each other. Hereinafter, an explanation will be made with reference to a timing chart shown in FIG. 5.

FIG. 5 is a timing chart illustrating ON/OFF control of the main printer body 51 and the docking station 52.

First, when the AC adaptor 55 is connected to the docking station 52 in a state in which the main printer body 51 and the docking station 52 are separated from each other, the station power circuit 41 starts (OFF→ON) by DC power supplied from the AC adaptor 55, such that an output of DC 3.3 V starts from the station power circuit 41. Then, the station control device 20 starts (OFF→ON). Here, in this state, the docking station 52 is in a standby state and is seemingly in a power OFF state (timing T1). In this state, even if the main printer body 51 is connected with the docking station 52, both the main printer body 51 and the docking station 52 maintain a power OFF state (timing T2).

Subsequently, while the main printer body 51 and the docking station 52 are being connected with each other, if the power switch SW of the main printer body 51 is pressed (timing T3) from the state where both the main printer body 51 and the docking station 52 are in the power OFF state, the station control device 20 that has detected the pressing of the power switch SW causes an operation state of the docking station 52 to switch from the power OFF state (stand-by state) to the power ON state and makes ON control on the transistor Q1. Supply of DC power from the AC adaptor 55 to the printer power circuit 31 starts by turning on the transistor Q1 and the printer power circuit 31 whose PC terminal has the GND potential starts (OFF→ON) by pressing of the power switch SW. Accordingly, an output of DC 3.3 V starts from the printer power circuit 31 and the printer control device 10 starts (OFF→ON). The printer control device 10 detects the pressing state of the power switch SW to hold the PC terminal of the printer power circuit 31 at the GND potential, and accordingly, the operation state of the main printer body 51 also switches from the power OFF state to the power ON state.

Subsequently, while the main printer body 51 and the docking station 52 are being connected with each other, if the power switch SW of the main printer body 51 is pressed again (timing T4) from the state where both the main printer body 51 and the docking station 52 are in the power ON state, the station control device 20 that has detected the pressing of the power switch SW causes the operation state of the docking station 52 to switch again from the power ON state to the power OFF state (stand-by state) and makes OFF control on the transistor Q1. The supply of DC power from the AC adaptor 55 to the printer power circuit 31 stops when the transistor Q1 is turned off, and accordingly, the printer power circuit 31 stops (ON→OFF). The DC 3.3 V output from the printer power circuit 31 stops and the printer control device 10 stops (ON→OFF), and accordingly, the operation state of the main printer body 51 also changes from the power ON state to the power OFF state.

Thus, in the state in which the main printer body 51 and the docking station 52 are connected with each other, supply of power from the docking station 52 to the main printer body 51 is turned on and off in conjunction with the power ON/OFF operation of the docking station 52 made by pressing the power switch SW and the power of the main printer body 51 is turned on and off in conjunction with the supply of power to the main printer body 51. Accordingly, the power of the main printer body 51 is turned on and off in conjunction with the power ON/OFF operation of the docking station 52 made by pressing the power switch SW.

Subsequently, if a power ON operation on the docking station 52 is performed using the remote control unit 60 (timing T6) from the state where the power of the docking station 52 separated from the main printer body 51 is in the OFF state (timing T5), the station control device 20 that has detected an output signal of the remote control unit 60 causes the operation state of the docking station 52 to switch from the power OFF state (stand-by state) to the power ON state and makes ON control on the transistor Q1.

When the main printer body 51 is connected to the docking station 52 that is in the power ON state (timing T7), DC power is supplied from the AC adaptor 55 to the printer power circuit 31 simultaneously with the connection. Accordingly, the output (OUT terminal) of the one-pulse circuit 32 has the GND potential only for a predetermined period of time. Since the PC terminal of the printer power circuit 31 changes to the GND potential when the OUT terminal of the one-pulse circuit 32 changes to the GND potential, the printer power circuit 31 starts (OFF→ON) by supply of power from the AC adaptor 55. Accordingly, an output of DC 3.3 V starts from the printer power circuit 31 and the printer control device 10 starts (OFF→ON). The printer control device 10 detects the state, in which the OUT terminal of the one-pulse circuit 32 changes to the GND potential, to hold the PC terminal of the printer power circuit 31 at the GND potential, and accordingly, the operation state of the main printer body 51 switches from the power OFF state to the power ON state.

Thus, in the docking station 52 that is in the power ON state, the station control device 20 makes ON control on the transistor Q1 regardless of connection with the main printer body 51. Moreover, if the main printer body 51 is connected to the docking station 52 in this state, the PC terminal of the printer power circuit 31 has the GND potential by the one-pulse circuit 32 at the point of time. Thus, the printer power circuit 31 starts to cause the printer control device 10 to start, such that power of the main printer body 51 is automatically turned on. That is, when a user connects the main printer body 51 to the docking station 52 that is in the power ON state, the power of the main printer body 51 is automatically turned on. Accordingly, the user can directly execute recording onto the recording paper P by operating the main printer body 51 without additionally operating the power switch SW of the main printer body 51.

Subsequently, while the main printer body 51 and the docking station 52 are being connected with each other, if a power OFF operation on the docking station 52 is performed using the remote control unit 60 (timing T8) from the state where the docking station 52 and the main printer body 51 is in the power ON state, the station control device 20 that has detected an output signal of the remote control unit 60 causes the operation state of the docking station 52 to switch from the power ON state to the power OFF state (stand-by state) and makes OFF control on the transistor Q1. The supply of DC power from the AC adaptor 55 to the printer power circuit 31 stops when the transistor Q1 is turned off, and accordingly, the printer power circuit 31 stops (ON→OFF). The DC 3.3 V output from the printer power circuit 31 stops and the printer control device 10 stops (ON→OFF), and accordingly, the operation state of the main printer body 51 also changes from the power ON state to the power OFF state.

Subsequently, while the main printer body 51 and the docking station 52 are being connected with each other, if the power ON operation on the docking station 52 is performed again using the remote control unit 60 (timing T9) from the state where the docking station 52 and the main printer body 51 is in the power OFF state, the station control device 20 that has detected an output signal of the remote control unit 60 causes the operation state of the docking station 52 to switch again from the power OFF state (stand-by state) to the power ON state and makes ON control on the transistor Q1. When the transistor Q1 is turned on, DC power is supplied from the AC adaptor 55 to the printer power circuit 31. Accordingly, the output (OUT terminal) of the one-pulse circuit 32 has the GND potential only for a predetermined period of time. Since the PC terminal of the printer power circuit 31 changes to the GND potential, the printer power circuit 31 starts (OFF→ON) by supply of power from the AC adaptor 55. Accordingly, an output of DC 3.3 V starts from the printer power circuit 31 and the printer control device 10 starts (OFF→ON). The printer control device 10 detects the state, in which the OUT terminal of the one-pulse circuit 32 changes to the GND potential, to hold the PC terminal of the printer power circuit 31 at the GND potential, and accordingly, the operation state of the main printer body 51 switches from the power OFF state to the power ON state.

Thus, by power ON/OFF of the docking station 52 performed by an operation using the remote control unit 60, the power of the docking station 52 is turned on and off. In conjunction with the power ON/OFF of the docking station 52, supply of power from the docking station 52 to the main printer body 51 is turned on and off. The power of the main printer body 51 is turned on and off in conjunction with the supply of power to the main printer body 51. Therefore, it is possible to turn on and off the power of the main printer body 51 in conjunction with the power ON/OFF operation on the docking station 52, which is performed by an operation using the remote control unit 60.

Subsequently, while the main printer body 51 and the docking station 52 are being connected with each other, the power switch SW of the main printer body 51 is pressed by an operation using the remote control unit 60 from the state in which both the main printer body 51 and the docking station 52 are in the power ON state. At timing T10, the station control device 20 that has detected the pressing of the power switch SW causes the operation state of the docking station 52 to switch again from the power ON state to the power OFF state (stand-by state) and makes OFF control on the transistor Q1. The supply of DC power from the AC adaptor 55 to the printer power circuit 31 stops when the transistor Q1 is turned off, and accordingly, the printer power circuit 31 stops (ON→OFF). The DC 3.3 V output from the printer power circuit 31 stops and the printer control device 10 stops (ON→OFF), and accordingly, the operation state of the main printer body 51 also changes from power ON to power OFF.

In addition, when the AC adaptor 55 is removed from the docking station 52 (timing T11), DC power is not supplied from the AC adaptor 55 to the docking station 52. Accordingly, the station power circuit 41 stops (ON→OFF) and the DC 3.3 V output from the station power circuit 41 stops, such that the station control device 20 stops (ON→OFF).

Thus, in the case of the ink jet printer 50 according to the embodiment of the present invention, it is possible to turn on and off the main printer body 51 and the docking station 52 at the same time only by performing power ON/OFF operation on any one of the main printer body 51 and the docking station 52 in the state in which the docking station 52 is connected with the main printer body 51. Therefore, when using the ink jet printer 50 in the state in which the docking station 52 is connected with the main printer body 51, it is not necessary to perform both the power ON/OFF operation on the main printer body 51 and the power ON/OFF operation on the docking station 52. Accordingly, it is possible to improve user's convenience in the ink jet printer 50 having the docking station 52.

In addition, it should be understood that the present invention is not limited to the above-described embodiment, but various modifications can be made within the scope and spirit of the present invention defined by the appended claims. Therefore, it is needless to say that the modifications are included in the scope of the present invention.

1. A recording apparatus comprising:
a first recording apparatus unit and a second recording apparatus unit configured to be separable from each other,
wherein in a state in which the first recording apparatus unit and the second recording apparatus unit are connected with each other, power of the first recording apparatus unit and power of the second recording apparatus unit are turned on and off simultaneously in conjunction with each other.

2. The recording apparatus according to claim 1,
wherein the first recording apparatus unit has a configuration capable of executing recording onto a recording material, and
the second recording apparatus unit has display operation means for the recording apparatus.

3. A recording apparatus comprising:
a main body of the recording apparatus having a configuration capable of executing recording onto a recording material and a docking station, the main body of the recording apparatus and the docking station being separable from each other,
wherein in a state in which the main body of the recording apparatus and the docking station are connected with each other, power of the main body of the recording apparatus and power of the docking station are turned on and off simultaneously in conjunction with each other.

4. The recording apparatus according to claim 3,
wherein the main body of the recording apparatus is configured to operate with power supplied from the docking station in a state in which the main body of the recording apparatus is connected with the docking station.

5. The recording apparatus according to claim 4,
wherein the docking station turns on and off supply of power to the main body of the recording apparatus simultaneously in conjunction with power ON/OFF of the docking station, and
the recording apparatus is turned on and off simultaneously in conjunction with ON/OFF of power supply from the docking station.

6. The recording apparatus according to claim 5,
wherein power of the recording apparatus is automatically turned on when the recording apparatus is connected to the docking station in which supply of power to the recording apparatus is in an ON state.

7. The recording apparatus according to claim 5,
wherein a contact state of a power switch of the connected main body of the recording apparatus is also input to the docking station, and
the docking station turns on and off power of the docking station in correspondence with an operation of the power switch of the main body of the recording apparatus and turns on and off supply of power to the main body of the recording apparatus simultaneously in conjunction with power ON/OFF of the docking station.

8. The recording apparatus according to claim 5,
wherein the docking station turns on and off supply of power to the main body of the recording apparatus simultaneously in conjunction with power ON/OFF of the docking station through a remote control operation.
